(19) United States
(12) Patent Application Publication
(10) Pub. No.: US 2005/0063314 A1
(43) Pub. Date: Mar. 24, 2005

(54) Method and system for content aware and energy efficient transmission of videos and images

(76) Inventors: Zafer Sahinoglu, Somerville, MA (US); Wei Yu, Greenbelt, MD (US); Anthony Vetro, Cambridge, MA (US)

Correspondence Address: Patent Department;Mitsubishi Electric Research Laboratories, Inc., 201 Broadway, Cambridge, MA, 02139, US

(21) Appl. No.: 10/665,606

(22) Filed: Sep. 19, 2003

(51) Int. Cl. H04L 12/26

(52) U.S. Cl. 370/252; 370/332

(57) ABSTRACT

A method selects source and channel codec parameters according to varying channel conditions and signal to noise ratio for a given distortion constraint. The processes of source and channel encoding and decoding with the selected parameter values and transmit power level per quality layer minimize a total energy consumption for delivery of multimedia content from a transmitting terminal to a receiving terminal. The total energy consumption is defined as the energy consumed while processing and transmitting the multimedia. Coding parameters, such as channel code rates, error resilience redundancy, unequal error protection level, and transmit power level can vary from layer to layer.

### FIELD OF THE INVENTION

This invention relates generally to energy efficient transmission of multimedia data, and more particular to energy efficient transmission of layered video and images such as JPEG2000 video and JPEG2000 images.

### BACKGROUND OF THE INVENTION

In general, wireless communications channels have a lower bandwidth and a higher bit error rate (BER) than wired channels due to severe channel conditions, such as path loss, fading, co-channel interference, and noise disturbances. Also, the throughput of the channels can fluctuate dynamically due to time varying characteristic of the channels. Overcoming the effects of the severe channel conditions is a major task in designing efficient transmission systems for multimedia, e.g., still images and videos.

Because multimedia tends to be highly redundant, it is preferred to apply compression to the source multimedia before transmission. The compressed multimedia has some special characteristics, such as unequal importance, error tolerance, and constrained error propagation. Unequal importance denotes that different parts of the compressed bitstream exhibits different perceptual importance. Error tolerance means that even if errors are introduced, the original information can still be reconstructed with minimal perceptual degradation.

To improve the compression efficiency, variable length coding (VLC) is used by most prior art multimedia compression systems. However, VLC is very sensitive to unpredictable errors. If some bits are corrupted, then neighboring bits can also become useless. This is called error propagation. By applying error resilient coding encoding procedures, the propagation can be restricted inside a certain range. This is called constrained error propagation.

These three characteristics differentiate multimedia transmission from general voice, text and data communication.

Multimedia applications are becoming more common in wireless communication networks, such as cellular telephone networks, local area networks, and home networks. When compared to traditional text, voice and data, multimedia requires more bandwidth, and therefore, more transmission power. In addition, increasing the power can decrease the bit error rate.

However, more and more user devices are battery operated. Minimizing energy consumption for delivery of multimedia is important for such devices.

Energy consumption can be decreased by decreasing the complexity of encoders and decoders, by using low power circuitries, and by using low signaling-cost routing protocols. Network topologies can also be exploited to reduce energy consumption by using relay assisted transmission and power combining methods with diversity gain techniques.

There is a trade-off between processing and transmission power consumption depending on the type and complexity of the multimedia, source and channel encoders in the transmitter, and source and channel decoders in the receiver.

A number of methods are known for energy efficient transmission. U.S. patent application 20030115428 of Zaccarin et al. Jun. 19, 2003 describes a power management system that monitors a data buffer to determine appropriate processor clock speed or voltage. That allows a processor to switch to low power states whenever possible. That method does not address error rates and wireless transmission requirements.

U.S. patent application 20030103469 of Setty et al. Jun. 5, 2003 describes a method for controlling transmission power in a time division duplex wireless telecommunication system. That method uses the size of the data and a midamble in a burst of data, and the change in rate matching to control the transmission power. However, that method also does not consider content, and only tries to maintain a predetermined SNR level for a minimum transmit power level.

U.S. patent application 20030101303 by Kung et al. describes a power-managing circuit for wireless communication. That circuit does not consider content characteristics.

U.S. patent application 20030100328 by Klein et al. May 8, 2003 describes a wireless local area network wherein mobile units receive beacon signals from access points. The access points control the power level of the mobile units. They do not consider adaptation of encoding procedures, channel conditions, or distortion constraints.

U.S. patent application 20030086443 by Beach et al. describes a wireless data communication system for packet communications. A monitoring apparatus at an access point monitors all transmitted packets and packet arrival rates. Voice packets are sent immediately to a mobile unit, while other packets can be buffered at the access point. Packet arrival rates vary due to random delays. The packet arrival rate and delays are used to determine required power levels.

U.S. patent application 20030083088 by Chang et al. May 1, 2003 describes a wireless communications network that includes transmission power and data rate adaptation based on signal quality. They adapt power and data transmission rates. There is no consideration for allocating power according to distortion constraint of the content.

U.S. patent application 20030083036 by Liu et al May 1, 2003 describes a wireless transmission circuit with adjustable transmission power. The power level depends on a distance to a receiver.

U.S. patent application 20030064744 by Zhang et al. Apr. 3, 2003 describes a method for reducing power consumption in mobile devices. Their power allocation method maximizes a total effective data rate in the channel.

Zhang et al., “Power-Minimized Bit Allocation for Video Communications Over Wireless Channels,” IEEE Trans. Circuits and Systems for Video Tech., v: 12, n: 6, 2002, describe a power allocation method that considers processing power for source encoding and channel encoding, as well as transmit power requirements. Their source coding method is strictly model-based. Their basic assumption is that one model works for all content. They also rely on an assumption that more complex source coding procedures achieve a lower bit rate. However, that is unrealistic in many cases. They also assume that the source processing power is decreased when the source rate is increased. That assumption cannot be generalized. They also erroneously assume that increasing the source rate requires more protection bits to satisfy distortion constraint. Those assumptions are due to the fact that their method is model-based. They consider complexity and energy consumption in a quantization process, but do not apply and consider error resilience source procedures and energy consumption with application of error resilience source encoding procedures.

Eisenberg et al., “Joint Source Coding and Transmission Power Management for Energy Efficient Wireless Video Communications,” IEEE Trans. Circuits and Systems for Video Tech., v: 12, n: 6, 2002, describe error resilience and concealment techniques at the source encoding level and transmission power management at the physical layer. They try to minimize overall transmission power. They couple expected distortion introduced by received packets only to source encoding parameters. That assumption neglects error propagation in the bit stream. Furthermore, their channel code and modulation rates are fixed. Their method operates off-line and is computationally complex, and it is therefore not suitable for real-time applications.

FIG. 1 shows the general features of prior art encoding systems. A joint source channel coding unit (JSCC) 150 receives a channel condition 160 and constraints 140, e.g., delay or distortion. Based on these inputs and a rate distortion model 120 provided by a source encoder 110, the JSCC determines a source-encoding procedure 130 for the source encoder 110.

The source encoder receives multimedia 105 and applies the source-encoding to the multimedia to produce a compressed bit stream 115. A channel encoder 125 performs channel coding by adding error correction bits to the compressed stream and returns a protected bit stream 190.

Some prior art systems use a channel encoder that has a fixed channel code rate. Other systems apply different channel code rates on the fixed compressed bit stream depending on channel conditions and power constraints. This is called joint source channel matching with power control. In that case, the JSCC provides the channel encoder with a channel rate 135.

Prior art systems generally treat transmit power control and source-channel matching independently. Typically, the transmitter 170 allocates a transmit power level for a certain bit error rate at the receiver based on the channel condition 160. Then, the channel coding is matched to the source coding according to allocated power. Therefore, the transmitter does not provide input to the JSCC 150. The bit stream 180 is typically transmitted at a predetermined power level.

Wei et al., in “Rate Efficient wireless Image Transmission using MIMO-OFDM,” Unversity of Maryland, Institute of Systems Research, Technical Report, TR-2003-30, August 2003, describe how to use error resilient coding schemes during a source encoding stage to minimize error propagation. That scheme jointly allocates a source coding rate, source error resilient coding schemes, channel coding schemes, and channel coding rates. However, that scheme does not consider total energy consumption of the system during the allocation, nor does that scheme consider power levels in the transmitter.

The prior art does not efficiently optimize the transmit power level for multimedia based on characteristics of the multimedia, channel conditions, and complexities of source and channel encoding and decoding units. Nor does the prior art attempt to minimize total energy consumption while satisfying a distortion constraint.

### SUMMARY OF INVENTION

In the present invention, a quality scalable bitstream with multiple quality layers is generated in an optimal rate-distortion (R-D) sense from source multimedia.

Given an estimated channel condition, content, and an end-to-end rate-distortion constraint, the invention determines adaptively the number of layers to be transmitted, and adjusts the source encoding rate, the channel encoding rate and the transmit power level jointly for each layer.

### BRIEF DESCRIPTION OF THE DRAWINGS

FIG. 1 is a block diagram of a prior art multimedia encoder;

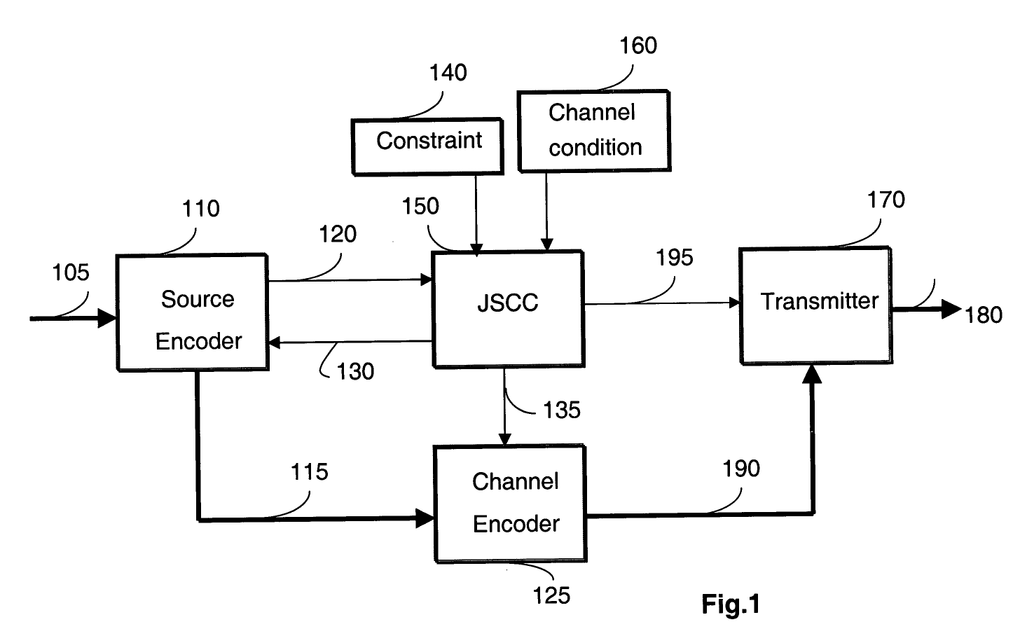

FIG. 2 is a block diagram of a multimedia encoder according to the invention;

FIG. 3 is a block diagram of layered bit streams according to the invention; and

FIG. 4 is a graph of an energy-distortion curve used by the invention.

### DETAILED DESCRIPTION OF THE PREFERRED EMBODIMENT

In a wireless communications network, transmission power is a major component of total energy consumption. Moreover, the energy consumption is proportional to the number of bits transmitted. Therefore, our invention minimizes energy consumption while meeting a predetermined quality of service (QoS) constraint for transmitting multimedia, e.g., still images, videos, voice, text, and data.

Our method selects an error resilient source encoder and a channel encoder according to dynamically varying channel conditions and signal to noise ratio (SNR) under a given rate-distortion constraint of the multimedia. The selected procedures and a selected transmit power level minimize total energy consumption for delivery of the multimedia from a transmitter to a receiver. The total energy consumption is defined as the energy consumption due to processing and transmitting the multimedia.

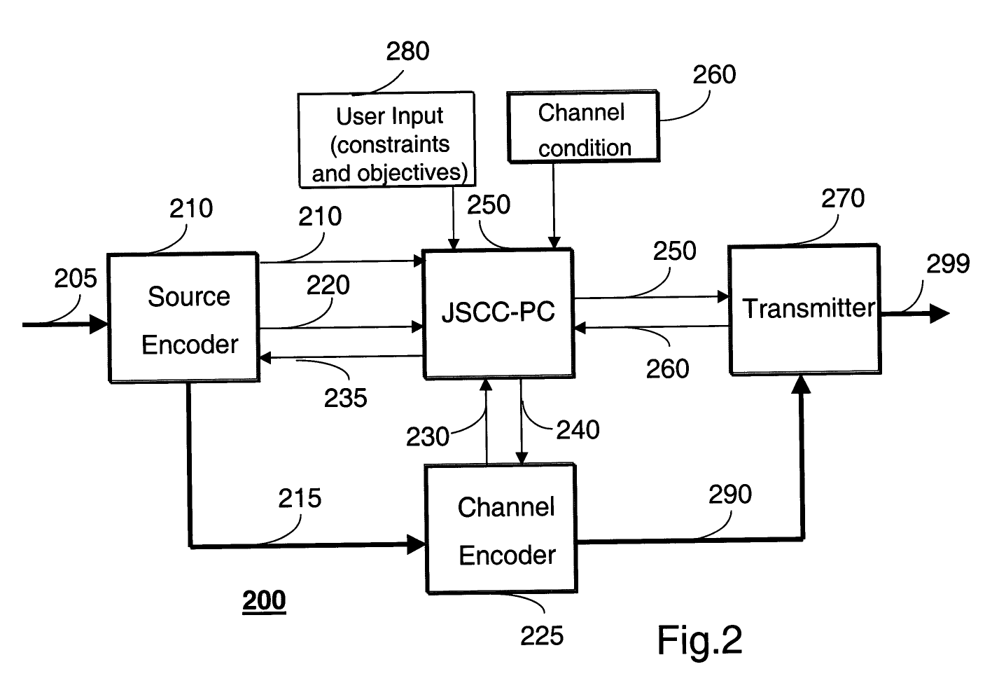

As shown in FIG. 2, we use an efficient joint source channel coding-power control (JSCC-PC) method and system 200. The method minimizes an objective function while satisfying a constraint based on energy and distortion. The objective function can minimize energy while meeting a minimum distortion requirement, or alternatively, the objective function can minimize distortion while meeting a minimum energy constraint.

From the source multimedia 205, the system 200 according to the invention generates a quality scalable bitstream 280, in a optimal rate-distortion (R-D) sense.

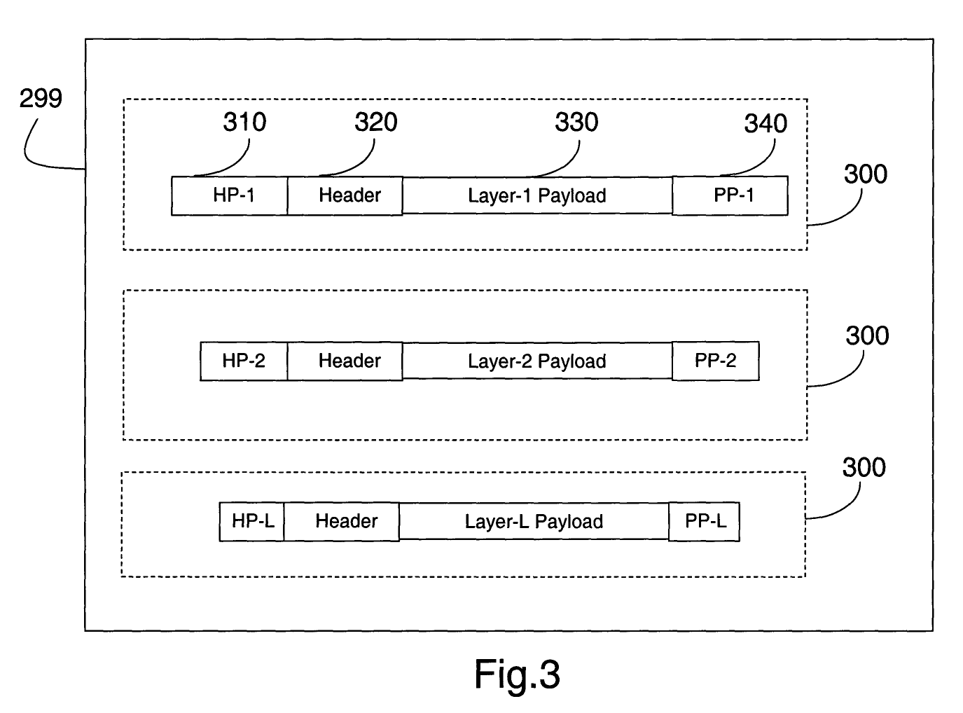

The bit stream 280 can include L layers 300, see FIG. 3. The transmitter 200 includes a joint source channel coding and power control unit (JSCC-PC) 250, which uses rate-distortion characteristics 210 of the actual multimedia 205 to be transmitted.

In addition to descriptions 220 of a set of source error resilience procedures available to the source encoder 210. The system also considers constraints and objectives 280, channel condition 260, a channel codes for channel encoder 225, and power levels of a transmitter 270. The channel condition can include bandwidth, signal-to-noise ratio, and delay.

In the preferred embodiment, the source encoding 210 is according to the JPEG 2000 standard, ISO/IEC, “ISO/IEC 15444-1:2000: Information technology—JPEG 2000 image coding system—part 1: core coding system,” 2000. However, it should be understood that other scaleable source encoders can also be used.

The channel encoder uses rate compatible punctured convolutional codes (RCPC), Hagenauer, “Rate-compatible punctured convolutional codes (RCPC) and their applications,” IEEE Transactions on Communications, vol. 36, no. 4, pp. 389-400, April 1988. To further improve the performance of the system, the transmitter power can vary over several levels, and can be adjusted dynamically by the system to meet current channel conditions.

As shown in FIG. 3, each layer 300 of the encoded multimedia has a layer header 320 and a layer payload 330, with bits n_{H} and n_{P} respectively. An average distortion/bit of layer i is dᵢ. An average error propagation per bit in layer i is bᵢ. Therefore, each quality layer can be defined by a vector <dᵢ, bᵢ, nᵢ>, where nᵢ is a total number of bits after applying error resilience source encoding and unequal error protection in fields 310 and 340 of each layer 300 of the bit stream 299.

The selected error resilience source encoding procedure is applied to the multimedia to produce a particular layer that minimizes errors introduced by the wireless channel. There is a set of S source error resilience procedures. A procedure Sᵢ ε S is applied to layer i, where i=1, . . . , L. The selected source encoding procedures are indicated by line 235. A difference between values 235 and 130 is that the value 235 specifies selected source encoding procedures, while the value 130 that the source encoding procedure is fixed.

Each layer 300 is also protected by channel codes. There is a set of C of channel encoding procedures 230 that produce the error correcting codes for the channel encoder 225. A channel encoder Cᵢ ε C is applied to layer i, where I=1, . . . , L. The invention uses selected channel encoding procedures that can be applied to the layers. A difference between 240 and 135 is that 240 specifies a selected set of channel coding procedures, while the value 130 specifies is a fixed procedure.

The transmitter 270 operates at several power levels, denoted by a set P 260. The set of possible transmit power levels for a layer i is denoted by Pᵢ ε P 250. A difference between 250 and 195 is that the value 250 specifies selected power levels, while the value 195 is a fixed power level.

The energy required to transmit one bit at power level Pᵢ is eᵢ^{t}. The source encoding, channel encoding, and power level of each layer i can be specified by a vector <Sᵢ, Cᵢ, Pᵢ>. The energy consumption, due to computational complexities introduced by applying vector <Sᵢ, Cᵢ, Pᵢ> on layer i is as eᵢ^{c}. We call this the processing energy consumption. This mainly takes place in three places: source encoding, channel encoding and baseband processing. For header protection, the energy consumption is determined by the code type and code rate, as well as the number of code words to be encoded. During decoding, the receiver end also consumes energy. Our method also takes that into consideration, and receiver energy consumption is included in eᵢ^{c}. Therefore, our method reduces energy for both the transmitter and the receiver. eᵢ^{c}The vector for layer i is denoted with Tᵢ for simplicity of the notation. The total energy consumption for processing, protecting and transmitting layer i is Eᵢ(Tᵢ)=eᵢ^{c}+nᵢeᵢ^{t}, where i=1, . . . , L. eᵢ^{c}After applying the source encoder, the channel encoder, and power level as specified in the vector Tᵢ, the distortion per layer i is Dᵢ(Tᵢ), for i=1, . . . , L. The JSCC-PC unit 250 selects the vector by minimizing an objective function and satisfying a constraint. The objective function can minimize overall energy consumption while satisfying the distortion constraint, or alternatively, the unit can minimize overall distortion while satisfying a energy constraint. The objective function and constraint can be formulated by

$${MIN}_{( {T}_{1} )} {\sum }_{l = 1}^{L} {E}_{1} ( {T}_{1} ) { s . t .}_{ ( {T}_{1} )} {\sum }_{l = 1}^{L} {D}_{1} ( {T}_{1} ) \geq \tilde{D} , and \\ {MIN}_{( {T}_{1} )} {\sum }_{l = 1}^{L} {D}_{1} ( {T}_{1} ) {s . t}_{( {T}_{1} )} . {\sum }_{l = 1}^{L} {E}_{1} ( {T}_{1} ) \geq \tilde{E} . \qquad ( 1 )$$

In the above, either the total energy consumption or distortion over L layers is minimized subject to a distortion or energy constraint, e.g., the overall distortion

$${\sum }_{l = 1}^{L} {D}_{l} ( {T}_{l} )$$

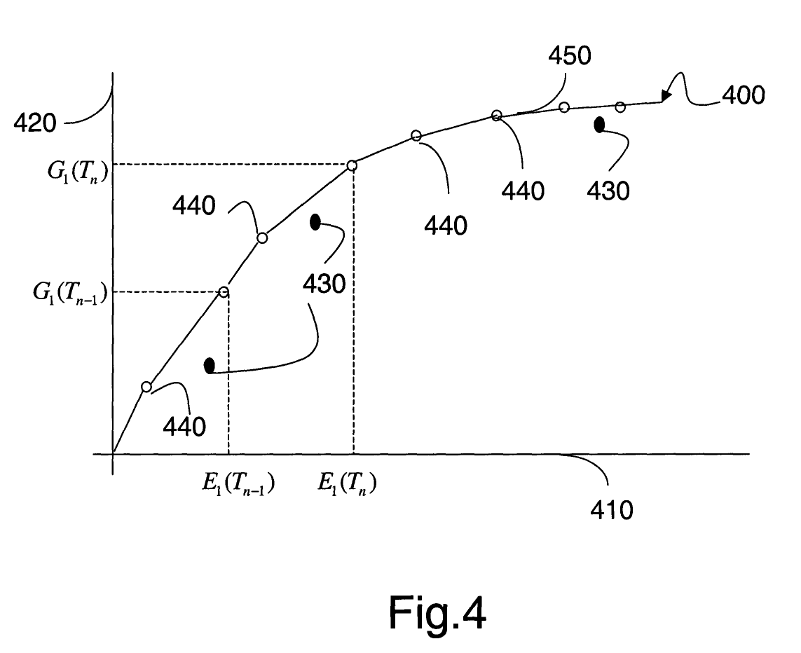

must be lower than a distortion threshold \tilde{D}. eᵢ^{c}The optimization-constraint problem given in Eq. 1 is solved with a convex hull analysis of an energy-distortion curve 400 as shown in FIG. 4. First, the JSCC-PC unit 250 computes the resulting energy consumption Eᵢ(Tₓ) and the reduction in distortion Gᵢ(Tₓ) by applying vector Tₓ=<Sₓ, Cₓ, Pₓ> on layer i, where x=1, . . . , M, and i=1, . . . , L. M is the number of vectors to consider.

The energy consumed when vector Tₓ is applied onto layer i is determined. This is repeated for all M vectors. The resulting M energy values are reordered in the increasing order 0<Eᵢ(T₁)<Eᵢ(T₂)< . . . <Eᵢ(T_{M}) 410.

The corresponding “reduction in distortion” values Gᵢ(Tₓ) 420 are also computed. Pairs of values (Eᵢ(T_{y}), Gᵢ(T_{y})) 430 that do not satisfy 0<Gᵢ(T₁)<Gᵢ(T₂)< . . . <Gᵢ(T_{M})) are discarded. The remaining M pairs 440 are kept for further consideration. In other words, all the feasible solutions reside on the convex hull of the energy-distortion curve 450 for that layer. The same process is performed for each quality layer.

After the feasible solutions for all the layers have been obtained, the optimal rate allocation and power control procedure for the optimization problem in equation (1) is solved as described below.

The following terminology is used
ΔGₗ(sₗ, s′ₗ)=Gₗ(s′ₗ)−G(sₗ): The distortion reductions by changing the vector for layer l from sₗ to s′ₗ.
ΔEₗ(sₗ, s′ₗ)=Eₗ(s′ₗ)−E(sₗ): The additional energy consumed by changing the vector for layer l from sₗ to s′ₗ;

$${g}_{l} ( {s}_{l} , {s}_{l}^{′} ) = \frac{{ΔG}_{l} ( {s}_{l} , {s}_{l}^{′} )}{Δ {E}_{l} ( {s}_{l} , {s}_{l}^{′} )} \text{:}$$

Normalized gain.
\tilde{G}: Gain target to achieve to satisfy distortion constraint.

Before the process begins, the reduction in gain is initialized to zero, i.e., G=0. Then, the following steps are performed.

For 1≦l≦L do

Find feasible procedure sets
Let sₗ=sₗ⁰, where sₗ⁰ is a feasible procedure set with a lowest energy consumption, and mark sₗ⁰.
   End for
   While G<\tilde{G} do
Find the layer l and the strategy s′ₗ, such that gₗ(sₗ, s′ₗ) is maximized among all layers and all unmarked strategies for this layer.
G=G+ΔGₗ(sₗ, s′ₗ);
Set the vector for layer l to sₗ=s′ₗ and mark s′ₗ;
   End while
   If G>\tilde{G} then
Let l be a last layer with the vector sₗ≠sₗ⁰, adjust the length of this last layer to be nₗ−nₗ(G−Gₘᵢₙ)/Gₗ(sₗ);
   End if

Return the set of selected vectors for all the layers and the length of the layer. By adjusting the length of the last layer to be transmitted, the optimal solution can be approximated very precisely.

After selecting the vectors for each layers, the vector is applied to that layer, and the bit stream is generated. Each vector indicates the source, the source error resilience procedure, channel en coding procedure, the channel en coding rate and the transmit power level to be used for the corresponding layer.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for encoding multimedia to be transmitted on a channel, comprising:
measuring a condition of the channel;
measuring rate and distortion characteristics of the multimedia;
providing a set of error resilient source encoding procedures;
providing a set of channel encoding procedures;
providing a set of transmitter power levels;
providing an objective function and a constraint based on energy and distortion; and
selecting jointly a particular error resilient source encoding procedure, a particular channel encoding procedure, and a particular power level based on the condition of the channel and the rate and distortion characteristics, while minimizing an objective function and satisfying a constraint.

2. The method of claim 1, in which the objective function minimizes energy while the constraint is a distortion.

3. The method of claim 1, in which the objective function minimizes distortion while the constraint is energy.

4. The method of claim 1, further comprising:
applying the particular error resilient source encoding procedure to the multimedia to produce a bit stream;
applying the particular channel encoding procedure to the bitstream to produce an output signal; and
applying the particular power level to the output signal for transmission.

5. The method of claim 1, in which the bitstream includes a plurality of layers, and the selecting is performed independently for each layer.

6. The method of claim 1, in which the condition includes bandwidth.

7. The method of claim 1, in which the multimedia include JPEG 2000 images.

8. The method of claim 1, in which the multimedia include moving-JPEG 2000 videos.

9. The method of claim 1, in which the objective function is minimized and the constraint is satisfied by analyzing an energy-distortion curve.

10. A system for encoding multimedia to be transmitted on a channel, comprising:
means for measuring a condition of the channel;
means for measuring rate and distortion characteristics of the multimedia;
joint source channel coding-power controller means for selecting jointly an error resilient source encoding procedure, a channel encoding procedure, and a power level based on the condition of the channel and the rate and distortion characteristics, while minimizing an objective function and satisfying a constraint;
a source encoder applying the error resilient source encoding procedure to the multimedia to produce a bit stream;
a channel encoder applying the channel encoding procedure to the bitstream to produce an output signal; and
a transmitter applying the particular power level to the output signal for transmission.
